(19) United States
(12) Patent Application Publication
(10) Pub. No.: US 2007/0225830 A1
(43) Pub. Date: Sep. 27, 2007

(54) Application activating method

(75) Inventors: Yuko Shimura, Kawasaki (JP); Katsuaki Akama, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/715,864

(22) Filed: Mar. 9, 2007

(30) Foreign Application Priority Data
Mar. 22, 2006 (JP) 2006-079604

(51) Int. Cl. G05B 11/01; G08B 1/00

(52) U.S. Cl. 700/16; 340/309.16

(57) ABSTRACT

An information processing apparatus for managing a schedule of at least one event includes a storage unit which stores the schedule of the event, an activation-date-and-time registering unit which registers, in a form associated with the event, an activation date and time at which an application is to be activated, an activation-date-and-time monitoring unit which monitors the registered activation date and time and determines whether the present time matches the activation date and time, an application-activation determining unit which, when the activation-date-and-time monitoring unit determines that the present time matches the activation date and time, determines whether the application is to be activated, and an application activating unit which activates the application when the application-activation determining unit determines that the application is to be activated.

### BACKGROUND OF THE INVENTION

1. Field of the Invention

The present invention relates to application operations in cellular phones.

2. Description of the Related Art

In recent years, with widespread use of cellular phones, the cellular phones have become provided with various functions. Many cellular phones have scheduling functions. Accordingly, there are a large number of users who perform schedule management by using the cellular phones. In addition to the scheduling functions, the cellular phones have various applications. By connecting to the Internet, the cellular phones can make reservations at restaurants and can purchase compact discs, books, etc.

When a schedule is registered in a cellular phone, at first, a user activates an application corresponding to a scheduling function and registers a schedule. In addition, an event notification function can notify the user that the present time matches the date and time of a registered event, and can display an event detail or the like on a screen of the cellular phone.

In addition, Japanese Unexamined Patent Application Publication No. 2004-78702 discloses a reservation requesting system that makes a reservation at a business place registered in a schedule.

According to a scheduling function of a cellular phone of the related art, a predetermined event is registered beforehand as a schedule. When the present time matches the date and time of the registered event, the scheduling function notifies a user that the present time matches the date and time of the registered event by using an alarm. Although the notification enables the user to know the registered event, when the user needs to perform an application operation for the event, the user must perform a predetermined operation after activating the application.

In addition, in the reservation requesting system disclosed in Japanese Unexamined Patent Application Publication No. 2004-78702, reservation requesting is performed in accordance with reservation requesting date and time of the schedule reserved beforehand and information of a location in which a reservation is made, whereby a reservation can be made at a business place without troubling the user. However, in the reservation requesting system disclosed in Japanese Unexamined Patent Application Publication No. 2004-78702, even if the user does not actually wish to activate the application at the date and time, the application is activated at the date and time of the registered reservation. Accordingly, the user cannot appropriately respond to the situation at the time.

### SUMMARY OF THE INVENTION

The embodiments of the present invention realize enabling smooth execution of an application operation concerning an event or the like registered in a schedule in accordance with a user's situation.

According to an aspect of the present invention, there is provided an information processing apparatus for managing a schedule of at least one event, the information processing apparatus including a storage unit which stores the schedule of the event, an activation-date-and-time registering unit which registers, in a form associated with the event, an activation date and time at which an application is to be activated, an activation-date-and-time monitoring unit which monitors the registered activation date and time and which determines whether or not the present time matches the activation date and time, an application-activation determining unit which, when the activation-date-and-time monitoring unit determines that the present time matches the activation date and time, determines whether or not the application is to be activated, and an application activating unit which activates the application when the application-activation determining unit determines that the application is to be activated.

According to the present invention, by determining whether or not an application is to be activated at a date and time when an application relating an event is set up to be activated, an information processing apparatus can smoothly execute an application operation in accordance with a user's situation.

### BRIEF DESCRIPTION OF THE DRAWINGS

FIG. 1 is a block diagram of an information processing apparatus according to an embodiment of the present invention;

FIG. 2 is a functional block diagram of a cellular phone according to an embodiment of the present invention;

FIGS. 3A, 3B, and 3C are conceptual diagrams of event schedule registration according to an embodiment of the present invention;

FIG. 4 is a flowchart showing task registration according to an embodiment of the present invention;

FIG. 5 is a flowchart showing task activation according to an embodiment of the present invention;

FIG. 6 is an illustration of an event management table according to an embodiment of the present invention;

FIG. 7 is an illustration of an event information table according to an embodiment of the present invention;

FIG. 8 is an illustration of a registered task identifier table according to an embodiment of the present invention;

FIG. 9 is an illustration of an activation-awaiting-task management table according to an embodiment of the present invention;

FIG. 10 is an illustration of an event-management table according to an embodiment of the present invention;

FIG. 11 is an illustration of an event information table according to an embodiment of the present invention;

FIG. 12 is an illustration of a registered task identifier table according to an embodiment of the present invention;

FIG. 13 is an illustration of a registered task identifier table according to an embodiment of the present invention;

FIG. 14 is an illustration of an activation-awaiting task management table according to an embodiment of the present invention; and

FIG. 15 is a flowchart showing task activation according to an embodiment of the present invention.

### DESCRIPTION OF THE PREFERRED EMBODIMENTS

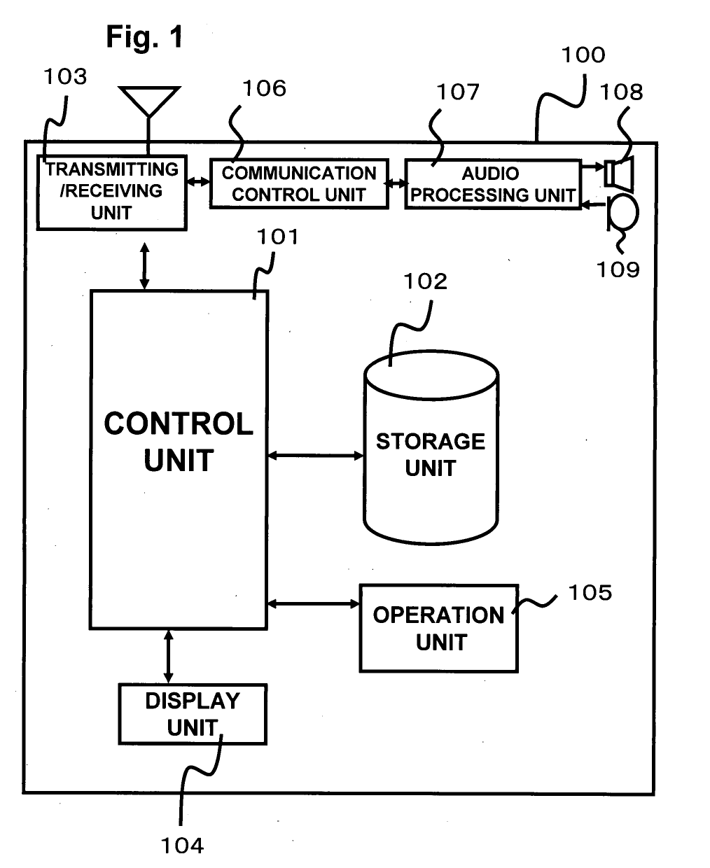

FIG. 1 is a block diagram showing the hardware of an information processing apparatus 100 according to an embodiment of the present invention.

The information processing apparatus 100 includes a control unit 101, a storage unit 102, a transmitting/receiving unit 103, a display unit 104, an operation unit 105, a communication control unit 106, an audio processing unit 107, a speaker 108, and a microphone 109. In this embodiment, a cellular phone is used as an example of the information processing apparatus 100 (hereinafter,referred to as the cellular phone 100). Obviously, the information processing apparatus 100 is not limited to the cellular phone, but may be an information processing apparatus, capable of having a schedule management function for performing schedule management, such as a personal computer or a personal digital assistance.

The control unit 101 is formed by a computer including a central processing unit (CPU), a read-only memory (ROM), and a random access memory (RAM), and performs various types of control of the storage unit 102, the transmitting/receiving unit 103, the display unit 104, and the operation unit 105. These types of control are performed by execution of a control program stored in the ROM of the control unit 101. The storage location of the control program is not limited to the ROM but may be another recording medium corresponding to the ROM.

The storage unit 102 collectively indicates a ROM, a RAM, etc. The storage unit 102 may be formed by a removable recording medium, and may be formed by, for example, a flash memory, or the like, as a memory in which stored content is not lost even if its power is switched off.

The transmitting/receiving unit 103 performs transmission and/or reception of wireless signal radio waves through an antenna. The communication control unit 106 generates wireless signal radio waves (to be transmitted and received) by performing modulation, demodulation, etc., on a carrier signal based on a call signal, a dial signal, or the like.

The audio processing unit 107 is connected to the speaker 108 and the microphone 109. The audio processing unit 107 converts an analog audio signal captured from the microphone 109 into a digital signal, and converts a digital audio signal output from the control unit 101 into an analog signal. The speaker 108 is used to play back the audio signal output from the control unit 101 and the audio signal captured through the microphone 109.

The display unit 104 includes LCD (liquid crystal display) elements, and displays various types of information input to and output from the control unit 101.

The operation unit 105 includes numeral keys, a call key, a call end key, function keys, and arrow keys. By using the operation unit 105, the user can input a telephone number and a mail address, and can call each function of the cellular phone 100 and can perform an operation on the function.

The control unit 101 functionally has a schedule management function, a task registration function, and a registered task monitoring function. With the schedule management function, for example, plans, such as user's meeting, a business trip, and a meal with friends, are managed with dates and times corresponding to such events. With the task registration function, an application task in accordance with a plan registered in a schedule by a user is registered. With the registered task monitoring function, it is monitored whether or not the present time matches a date and time at which the task registered with the task registration function, and activates a corresponding task. The task in this embodiment represents the entirety of processing performed by an application.

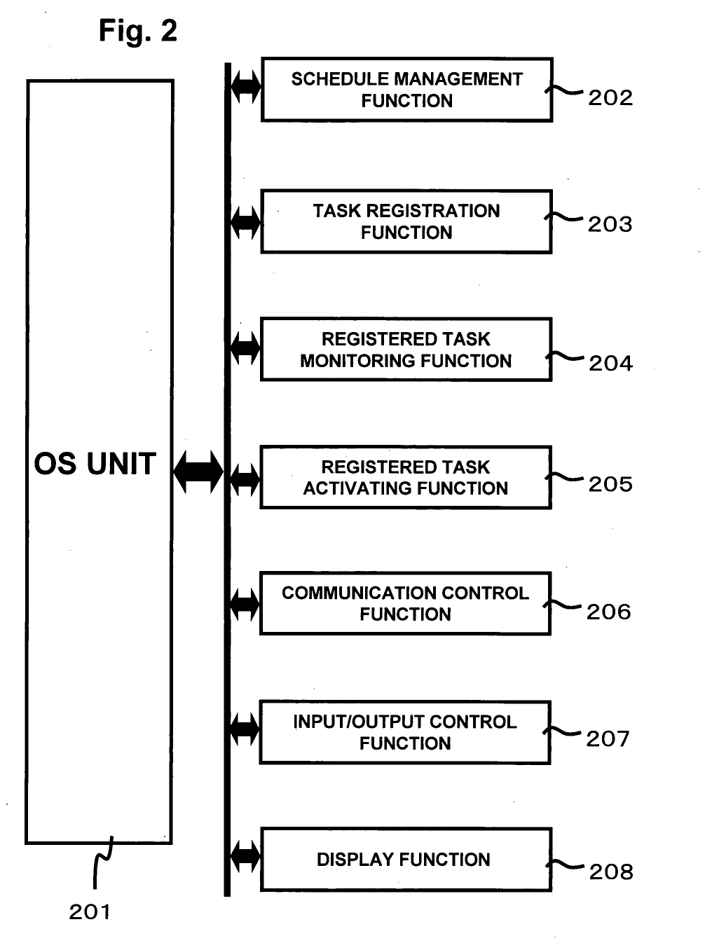

FIG. 2 is a functional block diagram of the cellular phone 100 according to this embodiment.

An OS (operating system) unit 201 manages the entirety of control of applications, etc., in the cellular phone 100. Processing by the OS unit 201 is performed by the control unit 101. In this embodiment, the OS unit 201 manages processes performed by a schedule management function 202, a task registration function 203, a registered task monitoring function 204, a registered task activating function 205, a communication control function 206, an input/output control function 207, and a display function 208.

The schedule management function 202, the task registration function 203, and the registered task monitoring function 204 are executed by the control unit 101, and control activation of a task in accordance with the event registered in the schedule.

The schedule management function 202 manages a schedule such as the date and time of the event registered by the user. The schedule management function 202 activates the display 208, and the display function 208 displays a calendar screen (hereinafter referred to as a calendar) on the display unit 104. A display style of the calendar is a display format in units of months. Obviously, the display format of the calendar may be, for example, a weekly display format. By operating the operation unit 105, the user can select a date of the calendar. When an event is registered, the schedule management function 202 performs event registration on the selected date on the basis of a user's operation on the operation unit 105.

On the basis of an operation on the operation unit 105, the task registration function 203 registers a task in connection with an event, a date and time at which a task is to be activated, etc. When the user uses the operation unit 105 to register an event, the OS unit 201 activates the task registration function 203. The task registration function 203 activates the display function 208, and the display function 208 displays a task registration screen on the display unit 104. The task registration function 203 registers an event-related task.

The registered task monitoring function 204 monitors whether or not the present time matches the date and time at which the registered task is to be activated. If it is determined that the present time matches the date and time at which the registered task is to be activated, the registered task monitoring function 204 activates the registered task activating function 205.

The registered task activating function 205 activates the display function 208, and the display function 208 displays, on the display unit 104, a task activation selecting screen for selecting whether the task is to be activated. If the user selects activation of the task, the task is activated. If the user selects no activation of the task, the display function 208 is activated. The display function 208 displays, on the display unit 104, a task re-registration selecting screen for selecting between whether the registered task activating function 205 no longer activates task and whether the task is to be later activated again. If no activation of the task is selected, the registered task activating function 205 finishes without activating the task. If later activation of the task is selected, the registered task activating function 205 activates the task registration function 203, and, on the basis of a user's operation, the task registration function 203 registers again a date and time at which the task is to be activated. If the user has selected no activation of the task on the task activation selecting screen, the registered task activating function 205 may finish without displaying the task re-registration selecting screen.

In addition, the communication control, function 206 is a function which is executed by the communication control unit 106, and which generates wireless signal radio waves (to be transmitted and received) by performing modulation, demodulation, etc., on a carrier signal based on a call signal, a dial signal, or the like.

The input/output control function 207 performs control of storing information input by the operation unit 105 into the storage unit 102, control of sending the analog audio signal input by the microphone 109 to the audio processing unit 107, and control of output of the audio signal from the speaker 108. The input/output control function 207 is executed by the control unit 101.

The display function 208 is a function which is executed by the display unit 104 and which displays operation and processing screens, etc., of each application in the information processing apparatus 100.

When the user performs event registration, the user uses the operation unit 105 to activate the schedule management function 202.

The schedule management function 202 allows the display function 208 to function to display the calendar on the display unit 104.

By using the operation unit 105, from the calendar, the user selects a desired date and time at which schedule registration is to be performed. When the desired date and time are selected, the display unit 104 displays a schedule registration screen corresponding to the selected date and time. The user uses the operation unit 105 to input the event. In this embodiment, the input of the event represents input of the name of the event (hereinafter referred to as an event name), a date and time (event date and time) at which the event is to be performed, and a setting (hereinafter referred to as an alarm setting state) of an alarm for notifying the user that the present time matches the event date and time.

When the event is input, the OS unit 201 activates the task registration function 203. The task registration function 203 activates the display function 208. The display function 208 displays the task registration screen on the display unit 104. The task registration function 203 registers an event-related task or the like. Here, the task represents processing of an application that is executable in the cellular phone 100. By using the operation unit 105, the user instructs the task registration function 203 to register a desired task. On the task registration screen, a plurality of tasks that can be registered are displayed, and the user selects a desired task from among the tasks. The number of tasks the user selects is not limited to one, but a plurality of tasks can be selected. Accordingly, tasks that are to correspond to event information are selected, if necessary. When task registration is not performed, on the task registration screen, the user finishes a task registration process performed by the task registration function 203 without selecting any task.

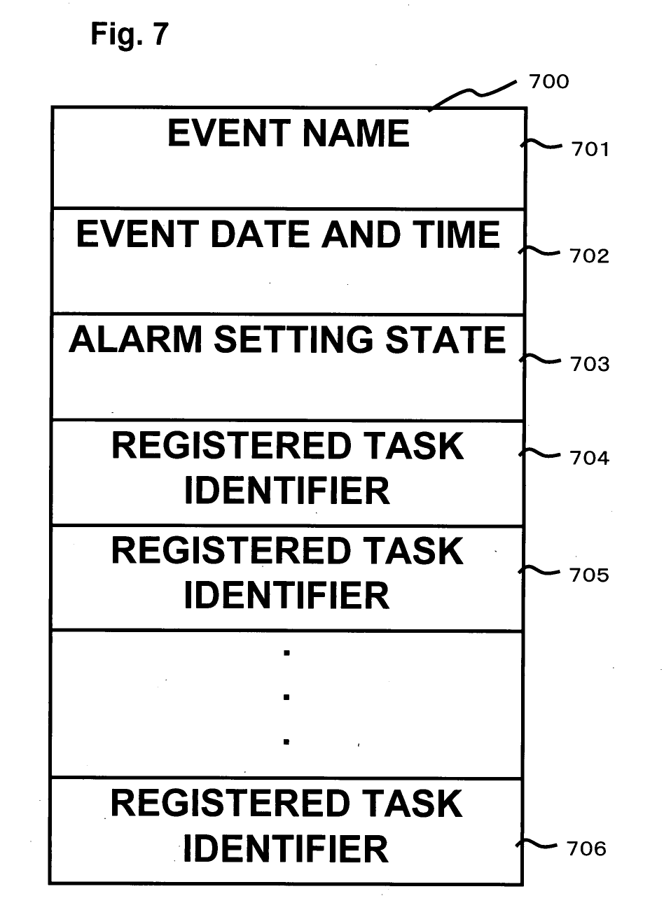

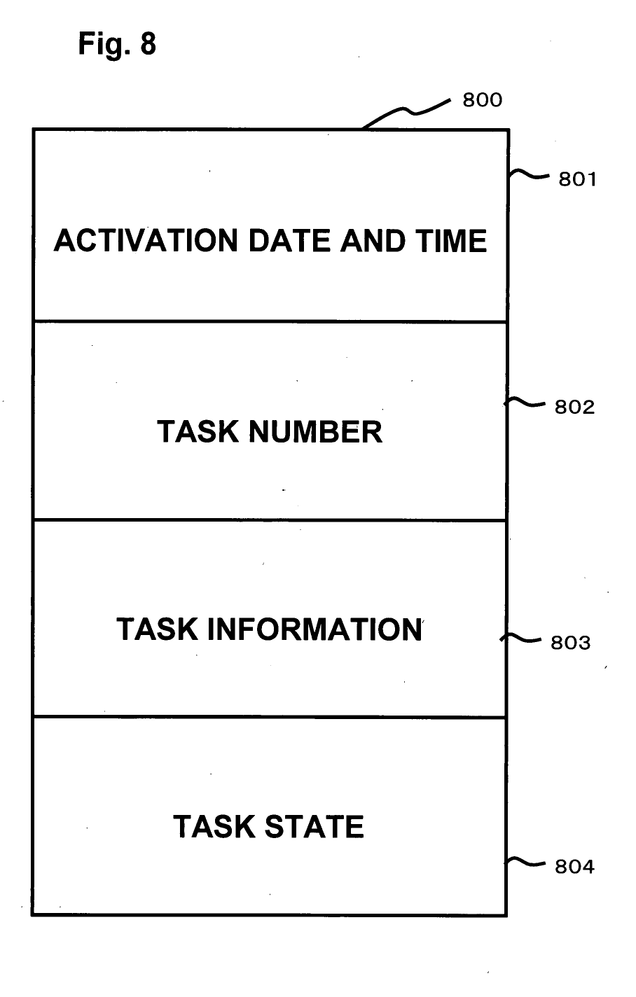

After the event is input and the task registration is performed, the OS unit 201 creates and stores the event information table 700 shown in FIG. 7 in the storage unit 102. The event information table 700 contains an event date and time, an event name, an alarm setting state, and registration task identifiers. Each registration task identifier represents a task registered by the user, and corresponds to the registration task identification table 800 shown in FIG. 8 which represents task information such as a task activation date and time. Similarly, the user inputs a different event and performs task registration, whereby a new event information table corresponding to the different event is stored in the storage unit 102.

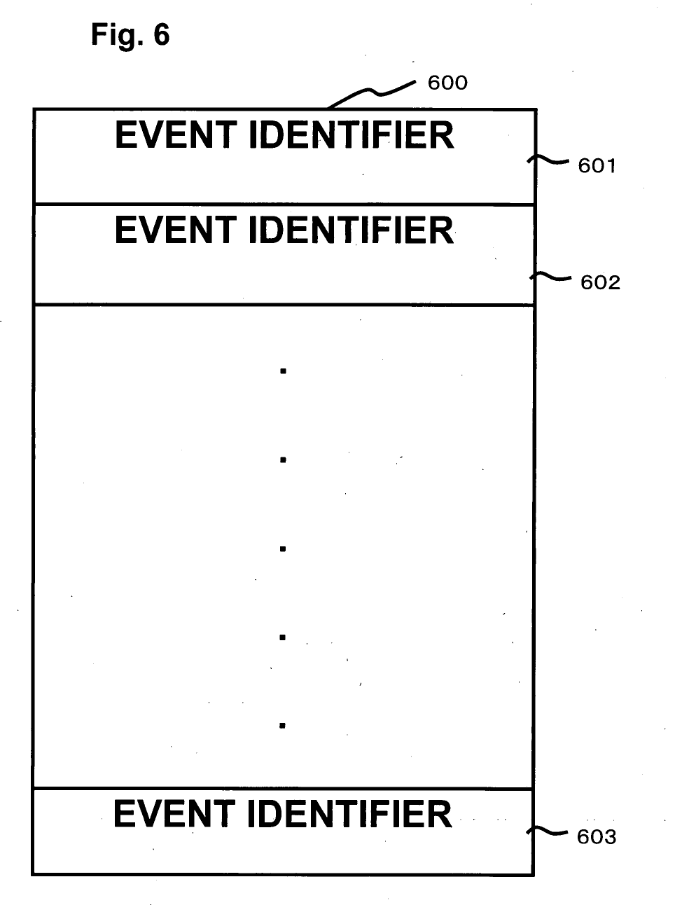

An event identifier corresponding to the event information table 700 is written in the event management table 600 shown in FIG. 6. The event management table 600 is stored in the storage unit 102. The event management table 600 is configured so that a plurality of event identifiers can be written. Each event identifier is associated with each event information table 700 corresponding thereto. In the event management table 600, event identifiers 601, 602, . . . , 603 are sorted in chronological order of event date and time. For event identifiers having the same event date and time, event identifiers corresponding to earlier registration dates and times can be disposed at higher positions.

When an event-related task exists, in order to monitor up to a date and time at which a registered task is to be activated, an activation-awaiting registered task identifier corresponding to the registered task is written in an activation-awaiting-task management table 900. Activation-awaiting registered task identifiers are sorted in such chronological order of that activation-awaiting registered task identifiers 901, 902, . . . , 903 are disposed from the top. When dates and times at which tasks are to be activated are identical, activation-awaiting registered task identifiers corresponding to tasks having earlier registration dates and times are disposed at higher positions. Here, the activation-awaiting-task management table 900 is stored in the storage unit 102. The registered task monitoring function 204 monitors activation dates and times of the tasks by using the activation-awaiting-task management table 900. When it is determined that the present time matches a date and time at which a task is to be activated, the registered task monitoring function 204 activates the registered task activating function 205.

The registered task activating function 205 activates the display function 208. The task registration function 208 displays, on the display unit 104, the task activation selecting screen for selecting whether the task is to be activated. On the task activation selecting screen, the user uses the operation unit 105 to select whether to activate the task whose activation date and time match the present time. When the user selects activation of the task, the registered task activating function 205 activates the task and deletes a corresponding activation-awaiting registered task identifier from the activation-awaiting-task management table 900. When the user selects no activation of the task, the display function 208 is activated to display, on the display unit 104, the task re-registration selecting screen for the user to select between whether to no longer activate the task and whether to later activate the task again.

When the user selects no activation of the task on the task re-registration selecting screen, the task activating process performed by the registered task activating function 205 finishes without activating the task. When the user selects later activation of the task on the task re-registration selecting screen, the registered task activating function 205 activates the task registration function 203. On the basis of a user's operation, the task registration function 203 registers a date and time at which the task is to be activated.

In addition, the OS unit 201 may be configured so that, after the OS unit 201 determines that an event finishes when the event date and time pass, the OS unit 201 performs deleting a corresponding event identifier from the event management table 600 and deleting the event information table 700 from the storage unit 102.

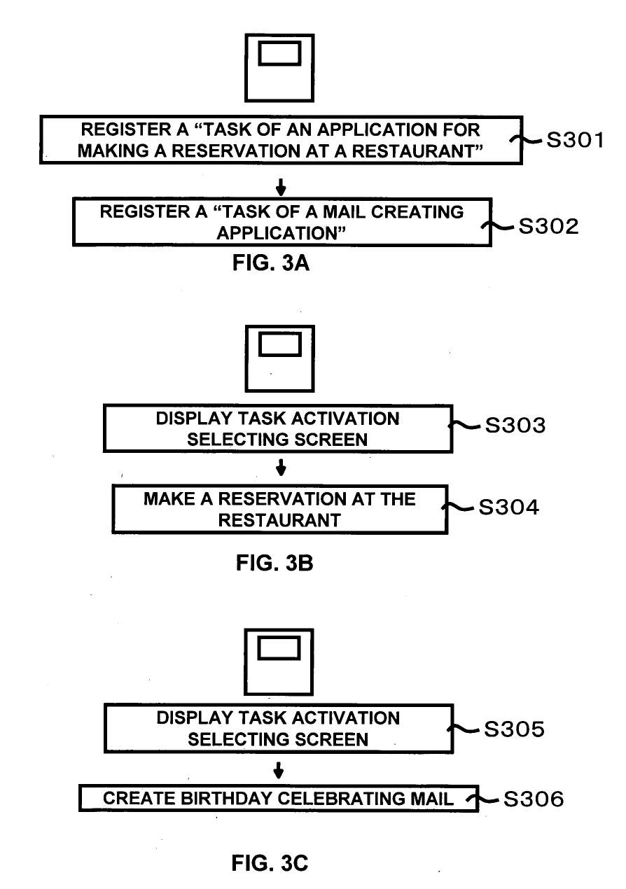

FIGS. 3A, 3B, and 3C are conceptual diagrams concerning event schedule registration according to this embodiment.

In this embodiment, the user registers a friend's birthday in a schedule. Correspondingly to the event of the friend's birthday, the user registers a task of a mail creating application for creating celebrating mail and a task of making a reservation at a restaurant.

Also, in this embodiment, in addition to the friend's birthday, events of soccer and a concert are registered. For the event of soccer, a task of knowing weather information, a task of reserving a ground, and a task of creating contact mail to attendees are registered. For the event of the concert, a ticket reservation task is registered. In this embodiment, task registration concerning the friend's birthday and a-task activating process are described. In the events of soccer and the concert, similar processing is performed.

FIG. 3A shows a registration concept at schedule registration.

By activating the schedule management function 202, the user inputs the event of the friend.'s birthday to perform event registration. For inputting the event, the following items are input. As an event name, “Taro's birthday” is input. As an event date and time, “date: Jul. 1, 2006, time: 12:00” are input. As an alarm setting state, “set” is input. In this embodiment, as the event date and time, only a date may be set without setting any time. In addition, when the alarm setting state represents “set” and the time is not set, alarm notification can be performed at 0:00. In this embodiment, when the event date and time is “date: Jul. 1, 2006, time: not set”, alarm notification is performed at 0:00 on Jul. 1, 2006.

After the event is input, the task registration screen is displayed on the display unit 104. The user registers a “task of a mail creating application” and a “task of an application for making a reservation at a restaurant” (S301, S302). The “task of the mail creating application” is hereinafter referred to as the mail creating task, and the “task of the application for making a reservation at a restaurant” is hereinafter referred to as a reservation task. The task registration screen is used to select between the mail creating task and the reservation task. After task registration, the user uses the operation unit 105 to finish the task registration process performed by the task registration function 203.

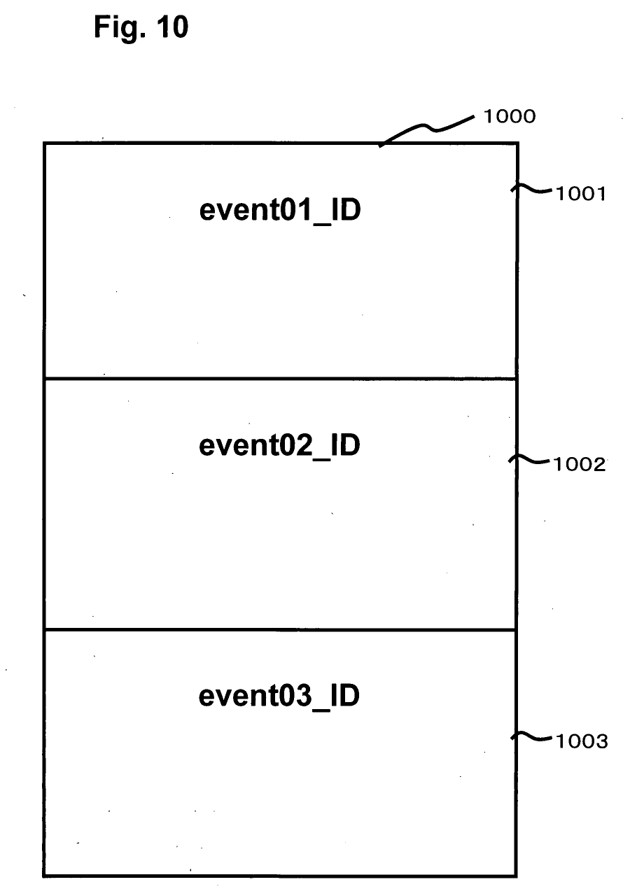

The OS unit 201 writes, in the event management table 1000 shown in FIG. 10, an event identifier 1001 corresponding to the input event (the friend's birthday). The event management table 1000 is stored in the storage unit 102. In this embodiment, the event identifier 1001 is written as event01_ID in the event management table 1000. Similarly, in the event management table 1000, an event identifier 1002 corresponding to the event of soccer is written as event02_ID, and an event identifier 1003 corresponding to the event of the concert is written as event03_ID. In the event management table 1000, event identifiers are sorted in such chronological order of event date and time that event01_ID, event02_ID, and event03_ID are disposed from the top. The event date and time of soccer is “date: Jul. 16, 2006, time: 09:00”, and the event date and time of the concert is “date: Jul. 29, 2006, time: 18:00”.

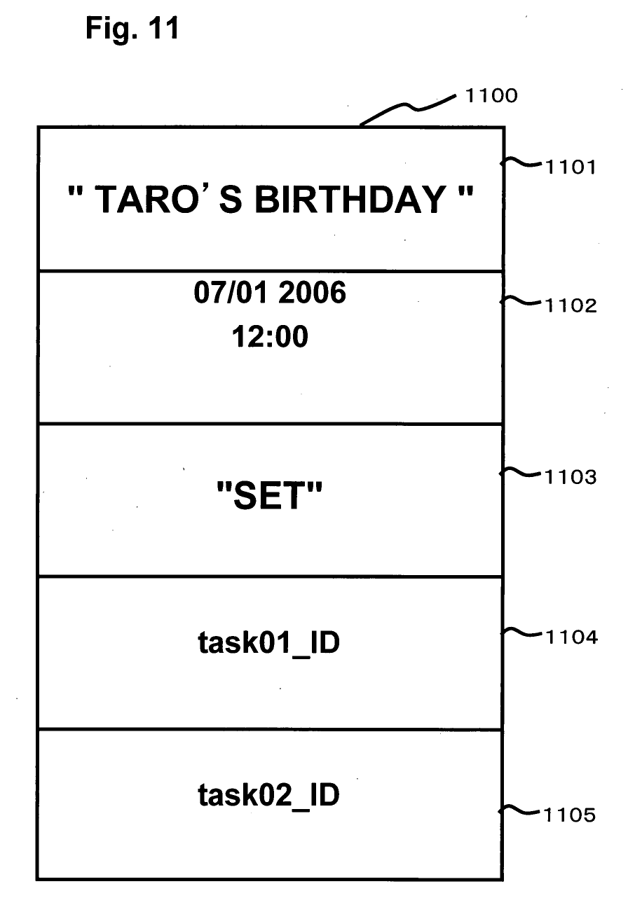

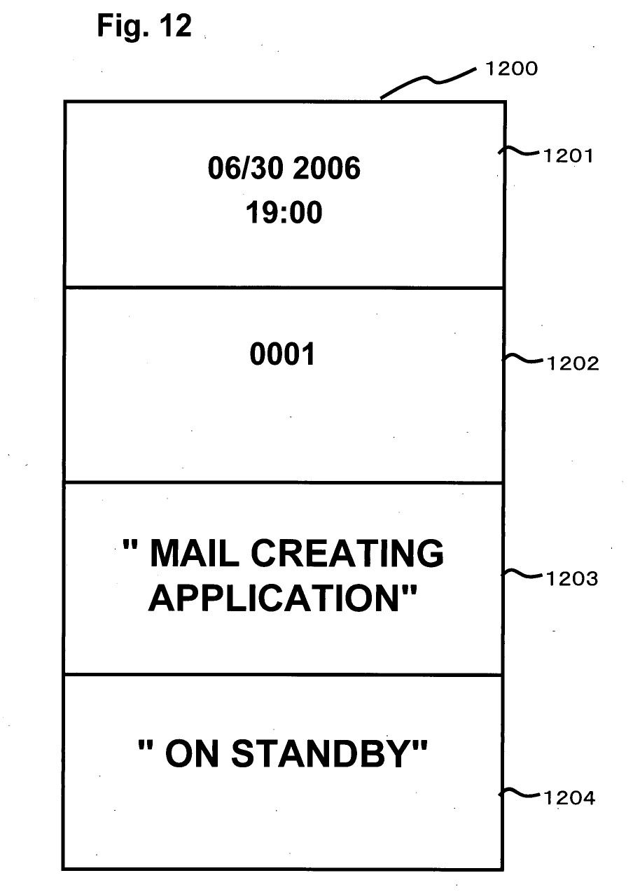

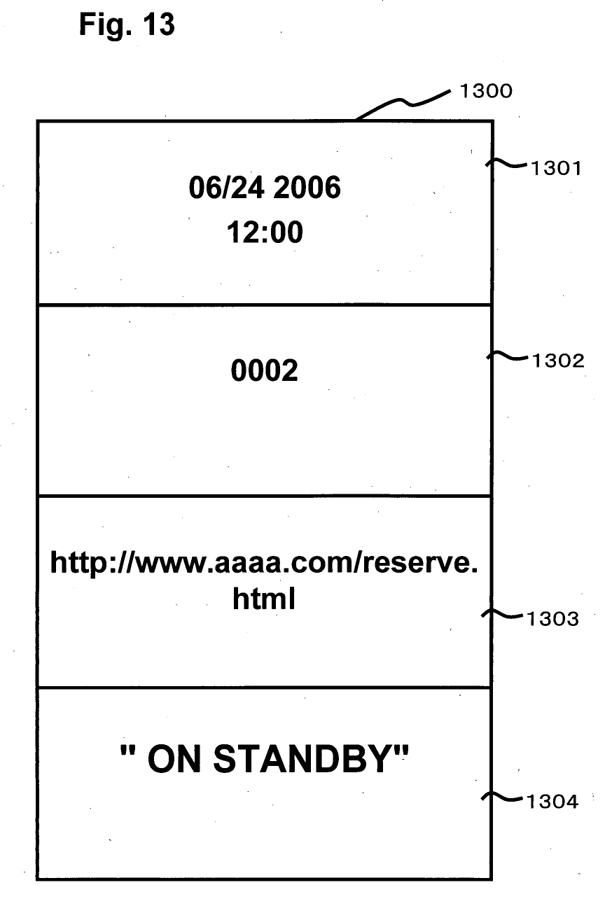

The event information table 1100 shown in FIG. 11 contains “Taro's birthday” as an event name 1101, “Jul. 1, 2006, 12:00” as an event date and time 1102, “set” as an alarm setting state 1103, task01_ID as a registered task identifier 1104, and task02_ID as a registered task identifier 1105. The event information table 1100 is stored in the storage unit 102. The registered task identifier 1104 corresponds to the mail creating task, and the registered task identifier 1105 corresponds to the reservation task. The registered task identifier 1104 corresponds to the registered task identifier table 1200 shown in FIG. 12, and the registered task identifier 1105 corresponds to the registered task identifier table 1300 shown in FIG. 13.

The registered task identifier table 1200 contains “date: June 30, 2006, time: 19:00” as a date and time (hereinafter referred to as an activation date and time) 1201 at which the mail creating task is to be activated, “0001” as a task number 1202 indicating that the task is the mail creating task, “mail creating application” as task information 1203 representing task information, and “on standby” as a task state 1204 representing the state of the task. Similarly, the registered task identifier table 1300 contains “date: Jun. 24, 2006, time: 12:00” as a reserved task activation date and time 1301, “0002” as a task number 1302 indicting that the task is reserved, “http://www.aaaa.com/reserve.html” as task information 1303 representing a URL,(uniform resource locator) of the reserved task, and “on standby” as a task state 1304. Both the registered task identifier table 1200 and the registered task identifier table 1300 are stored in the storage unit 102.

In order to monitor the mail creating task and the reserved task activation date and time, queue02_ID of an activation-awaiting reserved task identifier 1402 corresponding to the registered task identifier table 1200, and queue01_ID of an activation-awaiting reserved task identifier 1401 corresponding to the registered task identifier table 1300 are written in the activation-awaiting-reserved-task management table 1400. The activation-awaiting-reserved-task management table 1400 is stored in the storage unit 102. In addition, activation-awaiting registered task identifiers that correspond to tasks registered in the events of soccer and the concert are also written in the activation-awaiting-reserved-task management table 1400. Here, the activation date and time of a ticket reservation application in the event of the concert represent “date: Jul. 2, 2006, time: 10:00”. The activation date and time of a ground reservation application in the event of soccer represent “date: Jul. 2, 2006, time: 12:00”. The activation date and time of a contact mail creating application represent “date: Jul. 14, 2006, time: 18:00”. The activation date and time of a weather forecast information acquiring application represent “date: Jul. 15, 2006, time: 21:00”.

In addition, an activation-awaiting registered task identifier 1403 corresponding to the ticket reservation application is queue03_ID. An activation-awaiting registered task identifier 1404 corresponding to the ground reservation application is queue04_ID. An activation-awaiting registered task identifier 1405 corresponding to the contact mail creating application is queue05_ID. An activation-awaiting registered task identifier 1406 corresponding to the weather forecast information acquiring application is queue06_ID. These activation-awaiting registered task identifiers are also written in the activation-awaiting-reserved-task management table 1400. In the activation-awaiting-reserved-task management table 1400, the above activation-awaiting registered task identifiers are sorted in such chronological order of activation date and time that queue01_ID, queue02_ID, queue03_ID, queue04_ID, queue05_ID, and queue06_ID. Each activation-awaiting registered task identifier in which the registered task monitoring function 204 determines that the activation date and time of the task pass is deleted from the activation-awaiting-reserved-task management table 1400.

By referring to the activation-awaiting-reserved-task management table 1400, the registered task monitoring function 204 monitors the activation dates and times of the mail creating task and the reservation task.

FIG. 3B shows a processing concept in the case of activating a reserved task.

When the registered task monitoring function 204 determines that the present time matches the reserved task activation date and time “date: Jun. 24, 2006, time: 12:00”, the registered task monitoring function 204 activates the registered task activating function 205. The registered task activating function 205 activates the display function 208, and the display function 208 displays, on the display unit 104, the task activation selecting screen for selecting whether the reserved task is to be activated (S303). When the user selects activation of the reserved task, by referring to the registered task identifier table 1300, the registered task activating function 205 establishes a connection to “http://www.aaaa.com/reserve.html” and displays a restaurant reservation menu screen on the display unit 104. After that, the registered task monitoring function 204 deletes the registered task identifier table 1300 from the storage unit 102, and deletes the activation-awaiting reserved task identifier 1401 from the activation-awaiting-reserved-task management table 1400. Also, the user makes a reservation at the restaurant in accordance with the menu screen (S304).

When the user selects no activation of the reserved task, the display function 208 is activated to display, on the display unit 104, the task re-registration selecting screen for the user to select between whether to no longer activate the task and whether to later activate the task again.

When the user selects no activation of the task on the task re-registration selecting screen, the task activating process performed by the registered task activating function 205 finishes without activating the task. When the user selects later activation of the task on the task re-registration selecting screen, the registered task activating function 205 activates the task registration function 203. On the basis of a user's operation, the task registration function 203 registers an activation date and time at which the task is to be activated.

FIG. 3C shows a processing concept in the case of activating the mail creating task.

Similarly, regarding the mail creating task, when the registered task monitoring function 204 determines that the present time matches the mail-creating-task activation date and time “date: Jun. 30, 2006, time: 19:00”, the registered task monitoring function 204 activates the registered task activating function 205. The registered task activating function 205 activates the registered task activating function 205, and the display function 208 displays, on the display unit 104, a task activation selecting screen for selecting whether the reserved task is to be activated. When the user selects activation of the mail creating task, the registered task activating function 205 refers to the registered task identifier table 1200 and displays a mail creating menu screen on the display unit 104 (S305). After that, the registered task monitoring function 204 deletes the registered task identifier table 1200 from the storage unit 102 and deletes the activation-awaiting reserved task identifier 1402 from the activation-awaiting-reserved-task management table 1400. Also, the user creates birthday celebrating mail in accordance with the menu screen (S306).

When the user selects no activation of the mail creating task, the display function 208 is activated to display, on the display unit 104, the task re-registration selecting screen for the user to select between whether to no longer activate the task and whether to later activate the task again. When the user selects no activation of the mail creating task on the task re-registration selecting screen, the task activating process performed by the registered task activating function 205 finishes without activating the mail creating task. When the user selects later activation of the mail creating task on the task re-registration selecting screen, the registered task activating function 205 activates the task registration function 203. On the basis of a user's operation, the task registration function 203 registers an activation date and time at which the mail creating task is to be activated again.

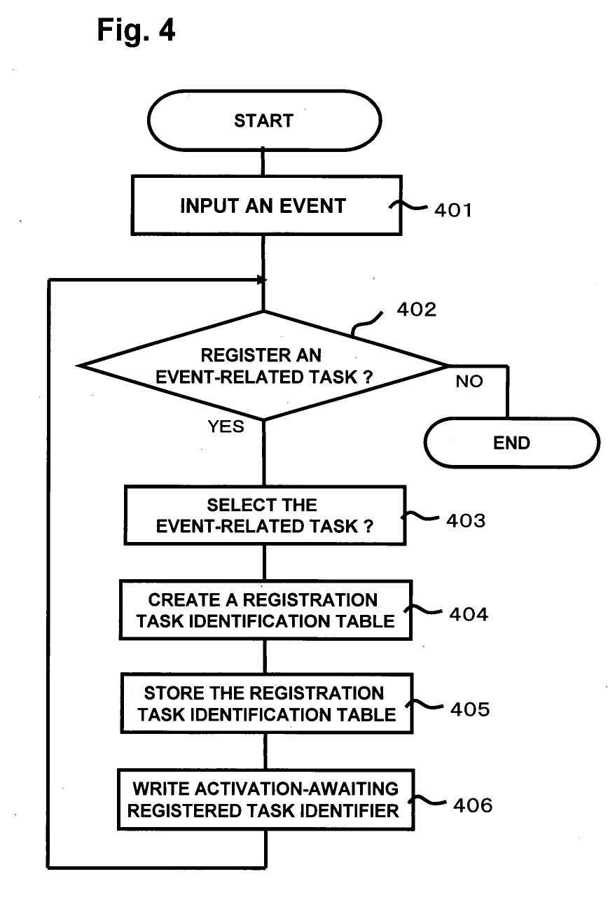

FIG. 4 is a flowchart showing task registration according to this embodiment of the present invention.

In step S401, as inputting an event, the user uses the operation unit 105 to input an event name, an event date and time, and an alarm setting state.

In step S402, the task registration function 203 determines whether or not there is an event-related task to be registered. In step S403, If there is the event-related task, a desired event-related task is selected from among a plurality of prepared tasks. In step S404, the registration task identification table 800, which corresponds to the selected task, is created. In step S405, the created registration task identification table 800 is stored in the storage unit 102. In step S406, the activation-awaiting registered task identifier 901 corresponding to the registration task identification table 800 is written in the activation-awaiting-task management table 900.

The task registration function 203 determines again whether or not there is a different event-related task (step S402). In this embodiment, for one event, a plurality of tasks can be registered. Obviously, for one event, only one task may be registered. When there is the different event-related task, steps S403 to S406 are similarly performed. If the task registration function 203 has determined that there is not any event-related task, the task registration process finishes.

The OS unit 201 creates and stores the event information table 700 in the storage unit 102. In the event information table 700, an event name 701, an event date and time 702, an alarm setting state 703, and registered task identifiers 704, 705, . . . , 706 are written. The registered task identifiers 704, 705, . . . , 706 represent event-related tasks, and are sorted in such order of task registration that registered task identifiers 704, 705, . . . , 706 are disposed. Each of the registered task identifiers 704, 705, . . . , 706 is associated with the registration task identification table 800, which represents task information.

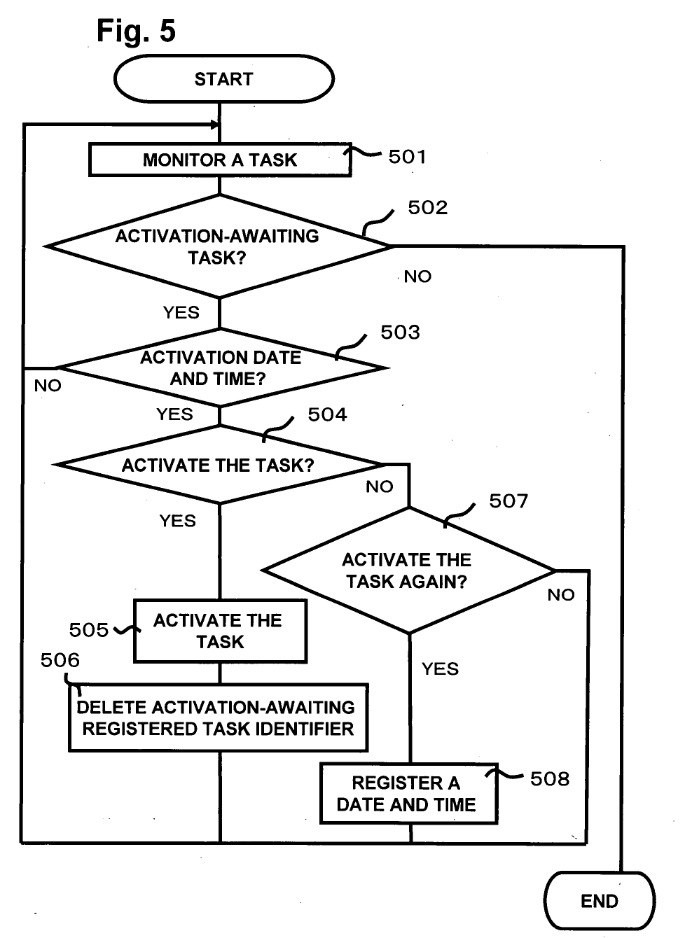

FIG. 5 is a flowchart showing task activation according to this embodiment.

In step S501, the registered task monitoring function 204 uses the activation-awaiting-task management table 900 to monitor a task activation date and time. The activation-awaiting-task management table 900 contains the activation-awaiting registered task identifiers 901, 902, . . . , 903. The activation-awaiting registered task identifiers 901, 902, . . . , 903 correspond to registered tasks, respectively.

In step S502, the registered task monitoring function. 204 determines whether or not there is an activation-awaiting task. If it is determined that there is the activation-awaiting task (YES in step S502), the registered task monitoring function 204 determines whether or not there is a task whose activation date and time match the present time (step S503). If the registered task monitoring function 204 has determined that there is the task whose activation date and time match the present time (YES in step S503), the registered task activating function 205 activates the display function 208. The display function 208 displays, on the display unit 104, the task activation selecting screen for selecting whether the task is to be activated. In step S504, the user selects whether to activate the task whose activation date and time match the present time. If the user has selected activation of the task (YES in step S504), in step S505, the registered task activating function 205 activates the task. In step S506, a corresponding activation-awaiting registered task identifier is deleted from the activation-awaiting-task management table 900. The activation date and time of a different task is monitored again (step S501). If the user has selected no activation of the task (NO in step S504), the display function 208 is activated to display, on the display unit 104, the task re-registration selecting screen for the user to select between whether to no longer activate the task and whether to later activate the task again. The display function 208 displays, on the display unit 104, the task re-registration selecting screen for selecting between whether the registered task activating function 205 no longer activates task and whether the task is to be later activated again. If the user has selected later activation of the task on the task re-registration selecting screen (YES in step S507), the registered task activating function 205 activates the task registration function 203. In step S508, on the basis of a user's operation, the task registration function 203 registers a date and time at which the task is to be activated again, and, in step S501, the registered task monitoring function 204 monitors an activation date and time again. If the user has selected no activation of the task on the task re-registration selecting screen (NO in step S507), the activation date and time of a different task are monitored again (step S501).

In addition, if the registered task monitoring function 204 has determined that there is not any task whose activation date and time match the present time (NO in step S503), a task activation date and time are monitored again (step S501).

If the registered task monitoring function 204 has determined that there is not any activation-awaiting task (NO in step S502), the registered task activating function 205 finishes the task activating process.

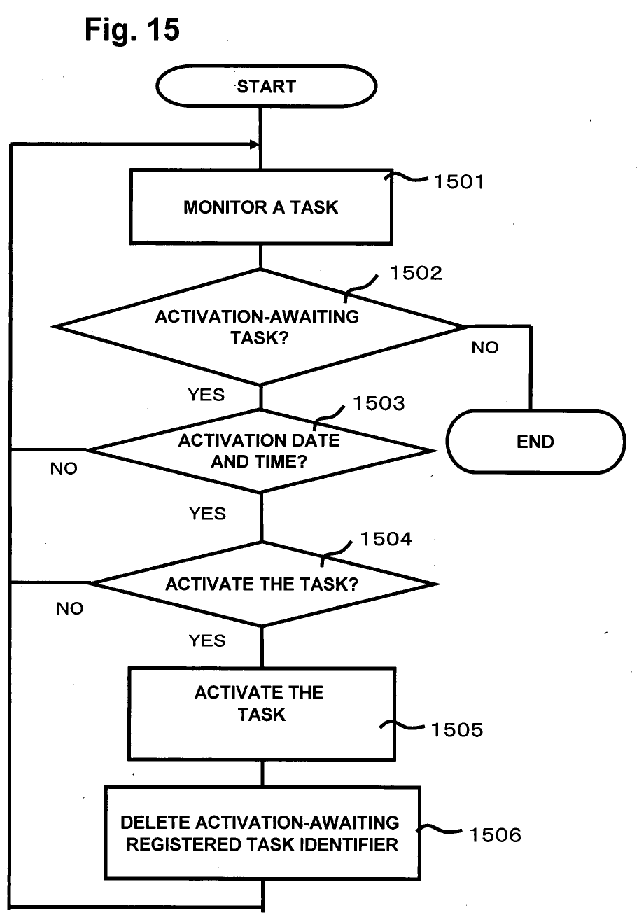

FIG. 15 is a flowchart showing task activation according to an embodiment of the present invention.

The flowchart shown in FIG. 15 differs from that shown in FIG. 5 and shows a case in which the task activating process is finished by the registered task activating function 205 without displaying the task re-registration selecting screen.

In step S1501, the registered task monitoring function 204 uses the activation-awaiting-task management table 900 to monitors a task activation date and time. The activation-awaiting-task management table 900 contains the activation-awaiting registered task identifiers 901, 902, . . . , 903. The activation-awaiting registered task identifiers 901, 902, . . . , 903 correspond to registered tasks, respectively.

In step S1502, the registered task monitoring function 204 determines whether or not there is an activation-awaiting task. If the registered task monitoring function 204 has determined that there is the activation-awaiting task (YES in step S1502), in step S1503, the registered task monitoring function 204 determines whether there is a task whose activation date and time match the present time. If the registered task monitoring function 204 has determined that there is the task whose activation date and time match the present time (YES in step S1503), the registered task activating function 205 activates the display function 208, and the display function 208 displays, on the display unit 104, the task activation selecting screen for selecting whether the task is to be activated. In step S1504, on the task activation selecting screen, the user selects whether to activate the task whose activation date and time match the present time. If the user has selected activation of the task (YES in step S1504), in step S1505, the registered task activating function 205 activates the task. In step S1506, the registered task activating function 205 deletes a corresponding activation-awaiting registered task identifier from the activation-awaiting-task management table 900. After that, the activation date and time of a different task are monitored again (step S1501). If the user has selected no activation of the task (NO in step S1504), the activation date and time of a different task are monitored again (step S1501).

If the registered task monitoring function 204 has determined that there is not any task whose activation date and time match the present time (NO in step S1503), the activation date and time of a different task are monitored again (step S1501).

If the registered task monitoring function 204 has determined that there is not any activation-awaiting task (NO in step S1502), the registered task activating function 205 finishes the task activating process.

Next, a table concerning registration of a schedule of events stored in the storage unit 102 in this embodiment is described below.

FIG. 6 shows the event management table 600 according to this embodiment.

The event management table 600 contains the event identifiers 601, 602, . . . , 603. The event management table 600 is stored in the storage unit 102. Each of the event identifiers 601, 602, . . . , 603 is associated with the event information table 700, which corresponds thereto. The event management table 600 has such chronological order of event date and time-that the event identifiers 601, 602, . . . , 603 are disposed from the top. For event identifiers having the same event date and time, an event identifier corresponding to an earlier registration date and time can be disposed at a higher position. In this embodiment, when an event date and time pass, the OS unit 201 determines that the event has finished, but does not delete an event identifier according to the event that has finished. In the event management table 600, the registered event identifiers can remain unless predetermined deletion is performed by the user. The OS unit 201 may be configured so that, when the OS unit 201 determines that the event has finished, the OS unit 201 can delete an event identifier corresponding to the event that has finished from the event management table 600.

Similarly, the event management table 1000 shown in FIG. 10 is used in the event schedule registration shown in FIGS. 3A to 3C. The information processing apparatus 100 is stored in the storage unit 102.

FIG. 7 shows the event information table 700 according to this embodiment.

The event information table 700 contains the event name 701, the event date and time 702, the alarm setting state 703, and the registered task identifiers 704, 705, . . . , 706. The event information table 700 is stored in the storage unit 102. Each registration task identifier represents a task registered by the user, and corresponds to the registration task identification table 800 shown in FIG. 8. The registered task identifiers 704, 705, . . . , 706 are sorted from the top in order in which corresponding tasks are registered. In this embodiment, when an event date and time pass, the OS unit 201 determines that the event has finished, but does not delete the event information table 700, which corresponds to the event that has finished. The event information table 700 remains stored in the storage unit 102 unless predetermined deletion is performed by the user. The OS unit 201 may be configured so that, when the OS unit 201 determines that the event has finished, the OS unit 201 can delete the event information table 700 from the storage unit 102.

Similarly, the event information table 1100 shown in FIG. 11 is used in the event schedule registration shown in FIGS. 3A to 3C. The event information table 1100 is stored in the storage unit 102.

FIG. 8 shows the registration task identification table 800 according to this embodiment.

The registration task identification table 800 contains an activation date and time 801, a task number 802, task information 803, and a task state 804. The registration task identification table 800 is stored in the storage unit 102. The activation date and time 801 represents a date and time at which a task is to be activated. The task number 802 is a number identifying each task. The task information 803 is task information, and the task state 804 represents the state of a task.

Similarly, the registered task identifier tables 1200 and 1300 are used in the event schedule registration shown in FIG. 3. The registered task identifier tables 1200 and 1300 are stored in the storage unit 102.

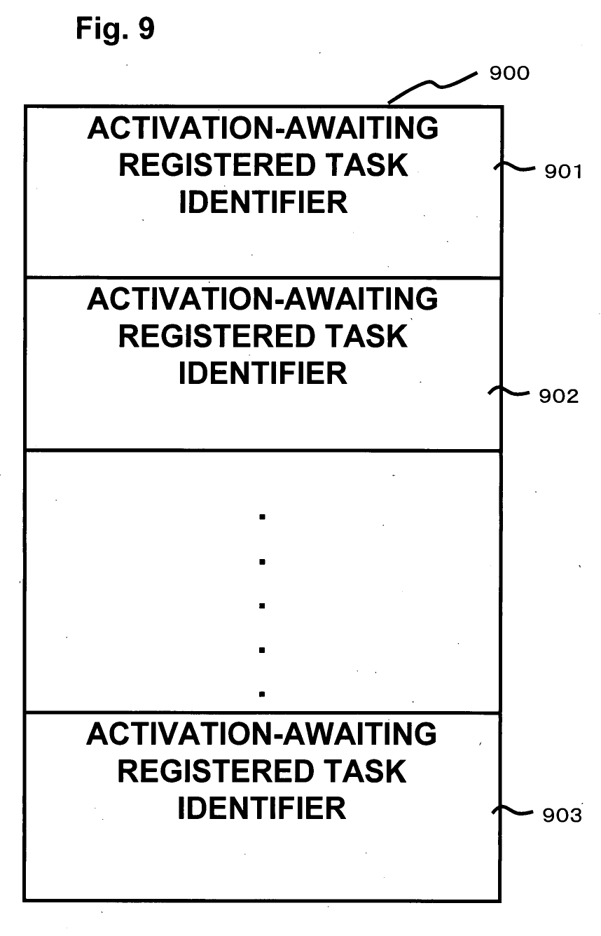

FIG. 9 shows the activation-awaiting-task management table 900 according to this embodiment.

The activation-awaiting-task management table 900 contains the activation-awaiting registered task identifiers 901, 902, . . . , 903. Each activation-awaiting registered task identifier corresponds to each registered task. The activation-awaiting registered task identifiers are sorted in such chronological order of activation date and time that the activation-awaiting registered task identifiers 901, 902, . . . , 903 are disposed from the top. When dates and times at which tasks are to be activated are identical, activation-awaiting registered task identifiers corresponding to tasks having earlier registration dates and times are disposed at higher positions. In this embodiment, when the registered task activating function 205 activates a task, the registered task activating function 205 deletes an activation-awaiting registered task identifier corresponding to the activated task from the activation-awaiting-task management table 900.

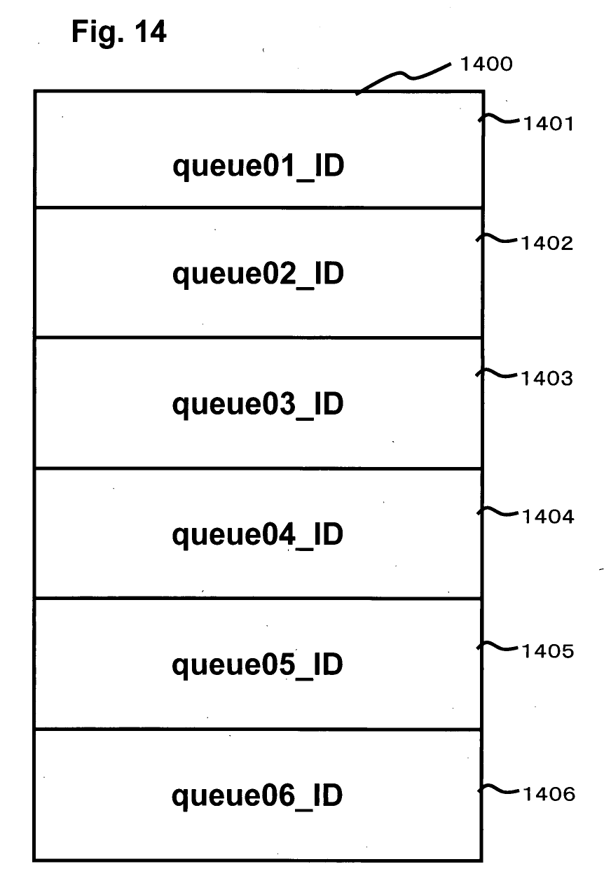

Similarly, the activation-awaiting-reserved-task management table 1400 shown in FIG. 14 is used in the event schedule registration shown in FIGS. 3A to 3C. The activation-awaiting-reserved-task management table 1400 is stored in the storage unit 102.

Technical ideas extracted from the foregoing embodiment of the information processing apparatus are described below as the Claims. Technical ideas according to the present invention can be understood from a generic concept to more specific concepts in various levels and variations, and the present invention is not limited to the foregoing embodiment.

In addition, processing that is executed by an activation-date-and-time registering unit, activation-date-and-time monitoring unit, application-activation determining unit, application activating unit, application-activation re-determining unit, and application-activation determining unit described in the Claims is executed by the control unit 101 in the foregoing embodiment.

What is claimed is:

1. An information processing apparatus for managing a schedule of at least one event, the information processing apparatus according to a process comprising:
storing a plurality of applications in a storage unit;
registering an activation date and time as to when to activate the application, the application being associated with the event;
notifying request of activating the application at the activation date and time;
displaying an application menu screen for being selectable the application from the plurality of stored applications; and
activating the application selected from the plurality of stored applications through the application menu screen to activate at the activation date and time.

2. The information processing apparatus according to claim 1, wherein the storage unit stores an activation-date-and-time table including the schedule of the event and an activation date and time when an application is to be activated.

3. The information processing apparatus according to claim 1, wherein the storage unit stores the schedule of the event, an event information table in which at least one application corresponding to the event is associated with the event, and an activation-date-and-time table including at least one activation date and time at which the application is to be activated.

4. An application activating method, for managing a schedule of at least one event, the application activating method comprising:
storing a plurality of applications;
registering an activation date and time as to when to activate the application, the application being associated with the event;
notifying request of activating the application at the activation date and time;
displaying an application menu screen for being selectable the application from the plurality of stored applications; and
activating the application selected from the plurality of stored applications through the application menu screen to activate at the activation date and time.

5. A computer-readable recording medium that stores a computer program for managing a schedule of at least one event by controlling an information processing apparatus according to a process comprising:
storing a plurality of applications in a storage unit;
registering an activation date and time as to when to activate the application, the application being associated with the event;
notifying-request of activating the application at the activation date and time;
displaying an application menu screen for being selectable the application from the plurality of stored applications; and
activating the application selected from the plurality of stored applications through the application menu screen to activate at the activation date and time.
